(19) United States
(12) Patent Application Publication
(10) Pub. No.: US 2005/0241893 A1
(43) Pub. Date: Nov. 3, 2005

(54) Support and guiding structure for friction element in disc brakes

(76) Inventor: Charles Stuart Goodreid, Coventry (GB)

Correspondence Address: HOWARD & HOWARD ATTORNEYS, P.C., THE PINEHURST OFFICE CENTER, SUITE 101, 39400 WOODWARD AVENUE, BLOOMFIELD HILLS, MI, 48304-5151, US

(21) Appl. No.: 10/451,031

(22) PCT Filed: Dec. 18, 2001
(86) PCT No.: PCT/GB01/05598

§ 371 Date: Jun. 1, 2005

(30) Foreign Application Priority Data
Dec. 18, 2000 (GB) 0030785.0

(51) Int. Cl. F16D 55/08

(52) U.S. Cl. 188/73.1; 188/72.1; 188/72.3

(57) ABSTRACT

Method and apparatus for friction element control in spot-type automotive disc brakes provides for use in a disc brake (10) of the kind comprising a fixed caliper (32) and at least one axially slidable disc (12, 14), a friction element mounting in which the friction clement (20) is supported on lengthwise guides (52) in the region of its circumferentially spaced ends (62, 64) and is further supported by an axially-extending abutment element (66) fixed to its upper edge and received in a channel (68) in the brake caliper (32). The abutment element an its channel serve to provide improved support for the friction element in resisting torque applied to the friction element during braking.

This invention relates to friction element control in disc brakes. An example of the application of the invention is to the control of friction elements in spot-type automotive disc brakes, particularly such brakes of the kind in which a fixed caliper and sliding friction elements are employed.

The invention may find an application outside the strict limits of the technical field of the disc brakes disclosed in the specific embodiments described below, but principally the invention is concerned with controlling the movement of friction elements in relation to the associated structures of a disc brake, particularly the disc or discs themselves (which rotate during use), and the relatively fixed or non-rotatable structures such as that of the caliper on which the friction elements are mounted.

Generally, the friction elements with which the invention is concerned are those which are not actually fixed to a position-defined structure such as the end plate of a fixed caliper and thus, the invention is particularly applicable to friction elements of the kind employed as the middle one of three friction elements interleaved with twin discs in a fixed caliper/sliding disc assembly as disclosed below.

In such a disc brake, a need arises for excellent dynamic control of the movement/position/attitude of the friction elements during brake application in order to maximise the effectiveness of the brake and minimise the extent of uneven wear during use.

In this connection, we have already disclosed in co-pending applications arrangements whereby the friction elements are provided with anti-tilt systems to maintain as far as possible the parallel and co-planar relationship of the friction-producing faces of the friction elements and of the brake discs themselves, and this has largely been achieved by means of spring arrangements exerting substantial resilient forces on the sliding disc assemblies and likewise on the sliding friction elements assemblies to achieve the necessary degree of control under the dynamic conditions of use.

Developments thus far have enabled us to provide a satisfactory degree of control in respect of those functions which may be conveniently grouped under the heading “anti-tilt control”, but we have discovered that there is a further area in relation to friction element control which requires attention in order to provide further advances in relation to the dynamic aspects of the performance of the disc brake itself.

These further factors which require attention concern principally the question of the response of the friction elements to the effect of the torque exerted thereon by the frictional forces during brake application.

Thus, it will be readily understood that upon brake application and frictional engagement of the friction pads with the rotating disc, the applied forces acting on the friction elements produce a torque due to the rotary motion of the brake discs and such torque or turning effect on the pad and thus on its backing plate and thus on the friction element as a whole can cause destabilisation of the friction elements leading to a reduction in brake efficiency, or possibly uneven wear of the friction pads, and an object of the present invention is to provide improvements in this regard in relation to friction elements for disc brakes, or indeed improvements generally.

According to the invention there is provided a method and apparatus as defined in the accompanying claims.

In embodiments of the invention described below the axially slidable friction elements are provided with the basic guide means and supporting means whereby they are able to execute supported axial movement for frictional engagement with the brake discs. However, in addition, the slidable friction elements are provided with abutment or torque-transmitting means in the form of an abutment or torque-transmitting element and an associated abutment or torque-transmitting channel in which the abutment or torque-transmitting element is received. These structures (provided respectively at the upper edge of the friction element and at the underside of the brake caliper) serve to provide an important abutment or torque-transmitting function for the friction elements whereby the potentially twisting effect of the braking torque applied by the rotating brake discs is effectively neutralised by the abutting engagement of the abutment or torque-transmitting element with its corresponding abutment or torque-transmitting channel. Moreover, although it would be possible to provide the abutment or torque-transmitting element as merely an upstanding peg or the like structure having the same thickness as the remainder of the friction element backing plate (and some benefit in terms of torque neutralisation would undoubtably be available), in the embodiments the abutment or torque-transmitting element is constructed so as to have a length dimension (extending lengthwise in the direction of the thickness of the backing plate material) whereby its torque neutralisation effects are significantly enhanced. It also potentially assists in guiding its friction element.

A particular feature of the embodiments is the location of the abutment or torque-transmitting element in relation to the line of action of the actuation means for the brake, such as the centre line of the actuating piston. In the embodiments, the abutment or torque-transmitting element is positioned directly above the line of action of the piston, and this is the preferred position. In the case where twin actuating pistons are provided, then a central position between the pistons (and thus effectively at the centre of pressure produced by the pistons) is preferred.

Embodiments of the invention will now be described by way of example with reference to the accompanying drawings in which:

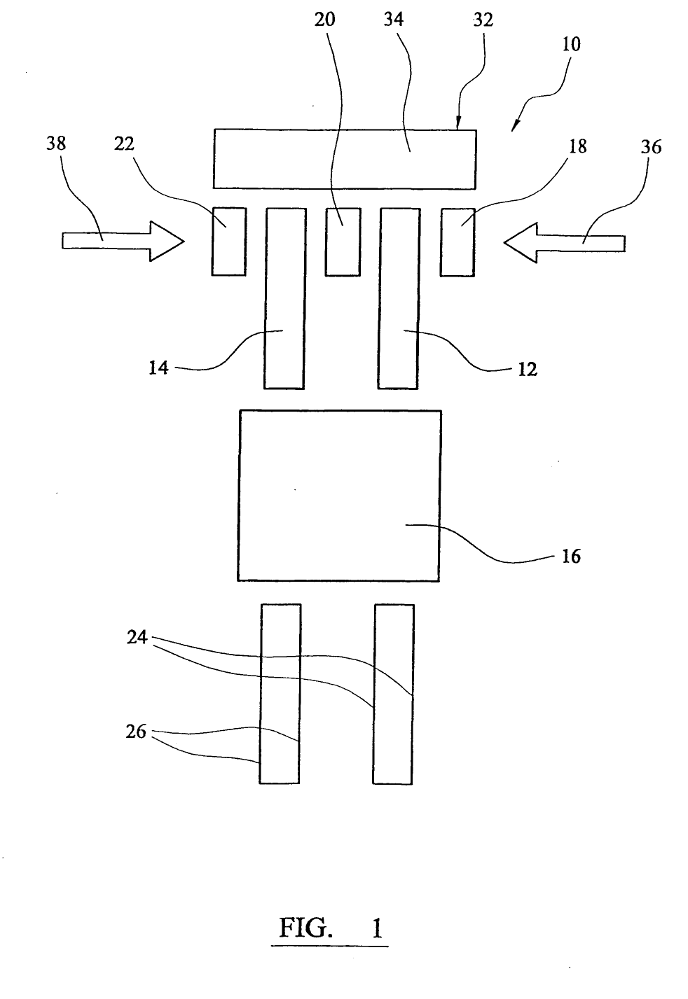

FIG. 1 shows, in block diagram format a spot-type automotive disc brake comprising a pair of axially slidable discs and associated friction elements, an actuating mechanism therefor and a fixed caliper or bridge structure overlying same;

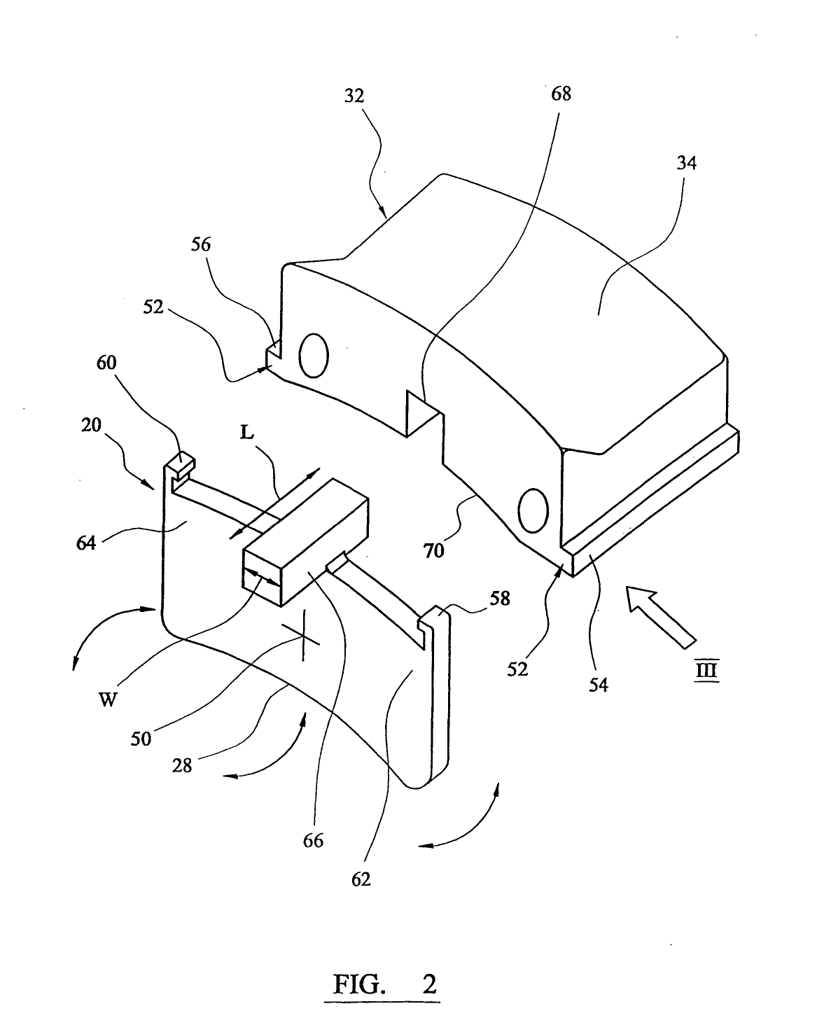

FIG. 2 shows on a somewhat larger scale an exploded perspective view of the caliper and an associated friction element with an abutment or torque-transmitting element shown at an upper edge of the friction element together with an associated abutment or torque-transmitting channel to receive same;

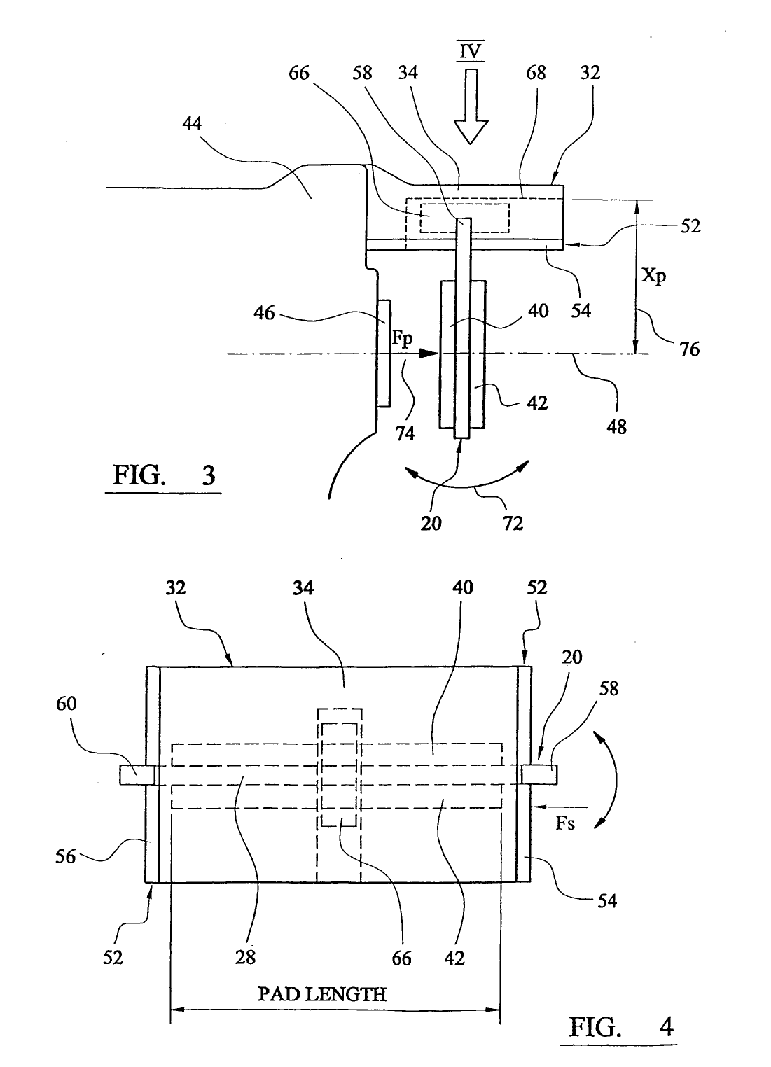

FIG. 3 shows a side elevation view of the assembly of FIG. 2 in its assembled condition; and

FIG. 4 shows a plan view, as seen in the direction of arrow IV in FIG. 3, of the assembly of FIGS. 2 and 3.

As shown in FIG. 1 a spot-type automotive disc brake 10 comprises a pair of rotatable brake discs 12, 14, a rotatable mounting 16 for the brake discs to permit rotation of the discs and which is adapted to drive the brake discs and have exerted thereon the braking effect by the discs when the disc brake 10 is actuated.

Two pairs of friction elements 18, 20 and 22 are provided and are adapted to frictionally engage braking surfaces 24, 26 provided at opposite sides of brake discs 12, 14 to effect braking on actuating actuation means for the brake. Central friction element 20 is double-sided for frictional engagement with the mutually-inwardly facing braking surfaces 24, 26 of brake discs 12, 14 and is provided with appropriately facing friction pad material accordingly. Friction elements 18, 20, 22 comprise (as shown in FIGS. 3 and 4) in each case a generally flat metal backing plate 28 and secured thereto and standing proud thereof a body of friction material of known construction for high durability frictional engagement with the relevant braking surface of the relevant brake disc. In the case of central friction element 20, the friction material is provided at both faces of the backing plate 28.

Brake discs 12, 14 are axially slidable in use with respect to their rotatable mounting 16 under the action of friction elements 18, 20, 22 and the actuation means (to be described below) therefor during braking. For example the brake discs may be keyed to the rotatable mounting or hub 16 at three or more locations and resilient means may act there between.

A non-rotatable mounting 32 for friction elements 18, 20, 22 is provided comprising a caliper or bridge structure 34 which is mounted on a fixed structure of the vehicle to be braked, for example on the wheel mounting and which straddles the brake discs 12, 14 and also provides a mounting for actuation means 36,38 (indicated diagrammatically) which applies inwardly directed braking forces to the outer friction elements 18, 22, thereby causing frictional engagement with the brake discs 12, 14, and slight sliding movement of those discs with respect to their rotatable mounting 16. In FIG. 1 of course it can be seen that the clearances between the structures have been greatly exaggerated for simplicity of diagrammatic illustration. The actuation means 36, 38 could comprise a pair of piston and cylinder assemblies. However only one such is strictly needed since the actuation means can be one-sided with a fixed structure at one side or the other of the assembly of discs and friction elements (which fixed structure could simply be a stop extending from caliper 34), and against which fixed structure the assembly is pushed by the single actuation means. Further details in this regard may be found in our co-pending applications WO 98/26192 (docket 2558).

Non-rotatable mounting 32 for the friction elements 18 to 22 is adapted to permit sliding movement of the friction elements into and out of frictional engagement with the brake discs while resisting movement of the friction elements under the action of frictional forces generated by engagement of the friction elements with the discs 12, 14.

Turning now to the details of the structures shown in FIGS. 2, 3 and 4, we mention first that the friction element illustrated is taken to be the central friction element 20 which (though not shown in FIG. 2) is provided as shown in FIGS. 3 and 4 with pads 40, 42 of friction material facing axially at its opposite sides.

Other structures seen in the drawings include the casting 44 to which caliper 34 is secured and from which the actuating piston 46 can extend under the action of the usual hydraulic and driver-controlled brake actuation system having a line of action 48 which of course intersects the friction elements, this location being shown in FIG. 2 at 50 which identifies the line of action of the centre of piston 46.

As also shown in FIGS. 2 to 4 axially-extending primary abutment or torque-transmitting means 52 is provided in relation to caliper 34 and is adapted to act on the slidable friction elements 20, 22 (end friction element 18 being secured or fixed to an end plate (not shown) extending downwards from the outboard end of caliper 34).

Primary guide means 52 comprises axially-extending guide rails 54, 56, one at each side of caliper 34 and adapted to receive corresponding hook elements 58, 60 provided at spaced locations namely the opposite circumferentially-spaced ends 62, 64 of friction element 20. Thus, guide rails 54, 56 and hook elements 58, 60 serve to ensure that friction element 20 (and likewise sliding friction element 22 in a similar way) is able to hang from the caliper for sliding axial movement lengthwise thereof towards and away from the brake discs 12, 14.

In addition to the guide rails 54, 56 and hook elements 58, 60 there is provided further abutment or torque-transmitting means comprising an abutment or torque-transmitting element 66 located intermediate spaced locations namely the opposite ends 62, 64 of the friction element and adapted to enable the friction element to resist torque from frictional forces applied to it during use of the brake, while permitting the friction element to move towards and away from the brake discs.

Abutment or torque-transmitting element 66 is received in an abutment or torque-transmitting channel 68 formed in the underside 70 of caliper 34.

It will be noted from FIG. 2 that abutment or torqur-transmitting element 66 is generally radially in-line with the line of action 48 of actuating piston 46 and indeed is directly above the piston centre line point 50.

FIG. 2 of the drawings shows the proportions of abutment or torque-transmitting element 66 in a clear manner with respect to the remainder of the friction element structure. Thus, the abutment or torque-transmitting element has an axial length L and a traverse width W such that L/W lies in the range of 2 to 3. In general, the ratio L/W should preferably be at least 1 and more preferably still in the range of 1 to 3. Such a ratio has the effect of maximising the abutment or torque-transmitting influence of the abutment or torque-transmitting element in relation to frictionally-developed torque forces applied to the friction element during use, thereby minimising the tendency for taper wear to develop in the pads 40, 42 of friction material.

The significance of the aspect ratio L/W in terms of maximising the torque-transmitting effect of the abutment or torque-transmitting element is discussed above. So far as the length aspects of the dimensions of the abutment element 66 are concerned, the following applies. As shown in FIG. 3, there is shown at 72 an indication of the possibility of friction element tilt in an axial plane which can occur when the brake is in its off condition. Such tilting is limited by engagement of abutment element 66 with the top of groove 68. The possibility of tilt in the mode indicated at 72 is decreased with increasing length of the abutment element 66. Likewise, a similar tilt-inhibiting effect is exerted by minimising clearance between the top of the abutment element 66 and the top of groove 68.

In the on condition of the brake, as indicated in FIG. 3, the brake-applying force Fp is indicated at 74 and acts along line 48 on the friction element 20 and has a turning (or taper wear) moment Fp×xp at the element 66 where xp is the radial distance (identified at 76) of off-set of line 48 from the top of channel 68. This force is resisted by a force at the end of the abutment element 66 acting on the top of groove 68 accordingly. This function likewise is enhanced by increasing the length of abutment or torque-transmitting element 66.

In use, disc brake 10 operates in substantially the usual manner, which is implicit from the above description, so far as concerns the general mode of frictional engagement of the relevant surfaces.

So far as guidance of the friction elements during use is concerned, the friction elements are supported on guide rails 54, 56 through hook elements 58, 60 and frictionally-developed torque forces applied to the pads 40, 42 of friction material which tend to produce twisting forces arising from the rotation of the brake discs are largely taken out of the friction element structure by the abutment or torque-transmitting element 66 and the engagement of same with the side walls of abutment or torque-transmitting channel 68 in which the abutment or torque-transmitting element is a close sliding fit. Indeed, in principle, the tolerances in relation to the sliding fit of abutment or torque-transmitting element 66 within abutment or torque-transmitting channel 68 are tighter (meaning a closer fit) than exists between hook elements 58, 60 and guide rails 54, 56. As a result, wear on the pads 40, 42 or friction material is greatly improved in terms of its uniformity throughout the total working area of the friction material.

Amongst other modifications which could be made in the above embodiment while remaining within the scope of the appended claims are changes to the shape and dimensions and exact location of the abutment or torque-transmitting element 66 in relation to caliper 34.

1-9. (canceled)

10. A method of mounting a friction element in a spot-type automotive disc brake, the disc brake comprising:
a) at least one rotatable brake disc;
b) a rotatable mounting for said brake disc to permit such rotation and which is adapted to drive said brake disc and to have exerted thereon a braking effect by said brake disc when the disc brake is actuated;
c) at least one pair of friction elements adapted to frictionally engage braking surfaces on opposite sides of said brake disc to effect braking on actuation of actuation means therefor and having a line of action intersecting said friction elements;
d) said brake disc being axially slidable in use with respect to said mounting therefor under the action of said friction elements and said actuation device therefor;
e) a non-rotatable axially fixed mounting for said friction elements adapted to permit axial sliding movement of at least one of said friction elements into and out of frictional engagement with said disc while locating same and resisting movement of same under the action of friction forces generated by engagement of same with said at least one disc;
f) axially-extending guide structure being provided in relation to said non-rotatable mounting and adapted to act on said at least one friction element at two spaced locations thereof; and said method comprising;
g) providing abutment structure adapted to resist torque applied to said at least one friction element and comprising an abutment element located intermediate said spaced locations of said friction element, and the method comprising causing same to resist torque applied to said friction element during use of said brake while permitting said friction element to move towards and away from said disc.

11. A method of mounting a friction element in a disc brake comprising an axially slidable disc, the method comprising providing guide structure adapted to act at two spaced locations on said friction element between said friction element and a non-rotatable mounting therefor, and said method comprising providing abutment structure located between said spaced locations on said friction element, and said method comprising causing said abutment structure to resist torque applied to said friction element during use of said brake.

12. A brake friction element comprising abutment structure located between guide structure at spaced locations of said friction element and adapted to resist torque applied to said friction element during use in a brake system.

13. A spot-type automotive disc brake comprising:
a) at least one rotatable brake disc;
b) a rotatable mounting for said brake disc to permit such rotation and which is adapted to drive said brake disc and to have exerted thereon a braking effect by said brake disc when the disc brake is actuated;
c) at least one pair of friction elements adapted to frictionally engage braking surfaces on opposite sides of said brake disc to effect braking on actuation of actuation device therefor and having a line of action intersecting said friction elements;
d) said brake disc being axially slidable in use with respect to said mounting therefor under the action of said friction elements and said actuation device therefor;
e) a non-rotatable axially fixed mounting for said friction elements adapted to permit axial sliding movement of at least one of said friction elements into and out of frictional engagement with said disc while locating same and resisting movement of same under the action of friction forces generated by engagement of same with said at lest one disc;
f) axially-extending guide structure being provided in relation to said non-rotatable mounting and adapted to act on said at least one friction element at two spaced locations thereof; and
g) abutment structure adapted to resist torque applied to said at least on friction element and comprising an abutment element located intermediate said spaced locations of said friction element, and adapted to resist torque applied to said friction element during use of said brake while permitting said friction element to move towards and away from said disc.

14. A disc brake comprising an axially slidable disc, and guide structure adapted to act at two spaced locations on a friction element and between said friction element and a non-rotatable mounting therefor, and said brake comprising abutment structure located intermediate said spaced locations and adapted to resist torque applied to said friction element during use of said brake.

15. A brake friction element comprising abutment structure located between circumferentially spaced ends of said friction element and adapted to resist torque applied to said friction element during use in a brake system.

16. A spot-type automotive disc brake according to claim 13, wherein said abutment structure is located generally radially in-line with the line of action of said actuation device.

17. A spot-type automotive disc brake according to claim 13, wherein said abutment structure comprises an abutment element fixed at the upper periphery of said at least one friction element and extending lengthwise in the direction of sliding brake-actuating motion of said friction element and slidingly received in a complementary channel formed in said non-rotatable mounting or caliper.

18. A brake according to claim 17, wherein said abutment element having a length-to-width ratio of at least in the range of 1 to 1 to 3 to 3.
